(19) United States
(12) Patent Application Publication
(10) Pub. No.: US 2023/0385915 A1
(43) Pub. Date: Nov. 30, 2023

(54) METHOD AND SYSTEM FOR PROVIDING AN ONLINE DIRECTORY AND MARKETPLACE FOR AESTHETIC RELATED SERVICES AND GOODS

(71) Applicant: AESTHETICS GLOBAL EVOLUTION LLC, SANTA MONICA, CA (US)

(72) Inventor: CHARMAINE ARNAUD, SANTA MONICA, CA (US)

(21) Appl. No.: 18/203,317

(22) Filed: May 30, 2023

Related U.S. Application Data
(60) Provisional application No. 63/324,955, filed on Mar. 29, 2022.

(51) Int. Cl. G06Q 30/0601

(52) U.S. Cl. CPC G06Q 30/0641; G06Q 30/0639

(57) ABSTRACT

A system and method for providing an online marketplace and directory for aesthetic services and goods. A platform where aesthetic service providers and aesthetic companies can register their services including details as to the types of services provided, the type of devices used, pertinent experience, credentials and certifications. Clients seeking aesthetic services can search by service and location. The platform will provide a list of pertinent aesthetic providers and companies within the specified location and service, where the client can access each provider and company and research information to determine the best provider and company for client needs. The client can then make an appointment with the company through the platform and make a payment for the services through the platform. The platform incorporates an activity feed where photos and videos can be uploaded by providers and companies for viewing, liking, sharing and commenting by users including companies, providers and clients. The platform allows for clients to rate their experience with a specific provider and/or company from 1 through 5, where a rating of 1 indicates the least satisfactory experience by a client and a rating of 5 indicates the most satisfactory experience by a client. The platform also incorporates the ability for clients to search and purchase aesthetic goods that are recommended based on the client's aesthetic needs. The platform also features a reward system where clients can gain rewards in the form of tokens that can be used for future services and purchase goods.

This application claims the benefit of U.S. Provisional Application No. 63/324,955, filed on Mar. 29, 2022.

### FIELD OF THE INVENTION

The present invention relates to an online service platform and marketplace where companies of aesthetic services can register their businesses and providers can register their aesthetic services either individually or as part of a business, and the clients can search and access the provider and company information and choose a desired aesthetic service. The online services integrate an activity feed where companies and providers can post pictures and videos for viewing, including but not limited to educational and marketing purposes. The online system includes an integrated reward system, where established vendors can offer incentives to clients. The platform will also feature home services, where clients can select providers and/or companies that provide in home services. The platform will also function as a marketplace where products specific to client needs, can be featured and recommended, and the client can purchase the product directly from the platform.

### BACKGROUND OF THE INVENTION

Aesthetic services are services for the upkeep and maintenance of the physical appearance and wellbeing of a person. These services include makeup artists, tattoo artists, medical professionals such as nurses and doctors, manicurists, hair stylists, masseurs, acupuncturists and etc. Aesthetic service providers are ubiquitous, and every individual uses or has used an aesthetic service provider. Most individuals either find the right aesthetic provider by trial and error or through recommendations of friends and family. The method of trial and error of finding the right aesthetic provider can be costly, can result in waste of time and effort and can be discouraging. When a person is seeking a specific service and specific results and the provider is unable to deliver, the client generally will find another provider to correct the errors of the original provider resulting in further waste of time and money.

Under the current market practice, seekers of aesthetic services are limited to google searches or other generalized searches, or discount platforms such as Groupon where information regarding each of the service provider must be checked in their website, seek reviews of the business through other platforms, call to make an appointment or visit their website, and manually check the location of the business. This process is time consuming and does not provide comprehensive information about the company and/or the provider that will be administering the aesthetic services.

Further, clients presenting a specific issue, such as hair loss, wrinkles, TMJ and etc., are limited to general internet searches to determine methods available to alleviate symptoms associated with the specific issue. These searches can provide inaccurate and unverified information from third-party sources and are not comprehensive which may lead a client to seek unnecessary and ineffective services and treatments.

In the current market providers and companies commonly do not provide prices for each of the services sought by a client. A client seeking a service will either need to call various providers or try to search their website to determine the prices for comparison, making the process time consuming.

There is a need for a streamlined and comprehensive method of searching and selecting qualified aesthetic service providers, reducing waste of time, money and unwanted results, that can be devasting and costly to correct.

The present invention seeks to bring aesthetic service providers around the world to one platform where a client can efficiently search by service and location and make an educated choice as to their aesthetic service provider. The client can read the qualifications and licensure of each provider, review their posts of before and after photos, read reviews of prior clients, ask questions through the chat feature, share photos and videos through the chat feature, if satisfied make an appointment immediately through the platform's calendaring system and tender the requisite payment through the platform. Further, the client can review pricing and make a payment through the platform, without any hidden fees. This effectively reduces unwanted results and allows clients to make the best decision as to an aesthetic service provider and provide a positive client experience. Further, satisfied clients have the option to share their experience with other clients in effect endorsing the aesthetic service provider through the platform. Further providers can build rapport with providers and follow them as they transition from one company to another company through the platform.

Further, the present invention allows clients to seek aesthetic service providers in specific locations around the world within a set mile radius utilizing global positioning system (GPS). This feature is helpful for clients who are new to an area or a country and need a specific aesthetic service. The online platform reduces search time by increasing accessibility to requisite aesthetic service providers, providing information for easy comparison between providers and allows for an efficient appointment scheduling system for in-office and convenient at home services. Further, the activity feed where providers and companies can post photos and videos can act as a marketing tool to promote their services to clients and increase visibility of both the company and the provider. The platform also serves as an online aesthetic employment tool for providers looking for an aesthetic company for work, and for those companies in need of providers. Providers and companies can host educational webinars on the platform further increasing engagement with other users on the platform and providing educational information in relation to their respective expertise.

All companies and providers seeking to be featured on the platform will be reasonably screened and verified to ensure that information presented on the platform is correct, including but not limited to education, years in practice, prior work experience and all qualifications. At random or upon notification, providers and companies will be selected for screening to ensure that the content provided by respective companies and providers is true and correct.

The invention will provide a secure payment feature, increasing booking efficiency and transactions. The invention will further incorporate a rewards program where clients will receive “tokens” when they book services that can be applied towards future services and goods to be purchased through the platform. The rewards program is meant to incentivize clients to book through the platform to gain tokens which can be reimbursed toward future services and other purchases made through the platform.

### SUMMARY OF THE DISCLOSURE

Various embodiments of the present disclosure are directed to an inventive system and a method of providing a comprehensive online service platform where qualified aesthetic companies and qualified aesthetic service providers can register and participate and offer their services to clients. Presenting on the platform can increase provider exposure for possible employment opportunities with companies and to serve as a method of finding qualified providers for companies. The invention provides an efficient calendar-based appointment system to allow for easy booking and cancelling. The invention further provides an activity feed where providers and companies can post videos and photos, increasing their visibility and reach to new potential clients.

The invention provides three different types of user profiles on the platform, a company user profile, a provider user profile and a client user profile. The company user is an organization that employs individual providers who provide various aesthetic services. The provider users can either be registered individually or be linked to one or more registered companies. The client users are the individuals that are seeking aesthetic services on the platform. The platform allows one individual to have a company user profile, a provider user profile if they are a provider themselves and a client user profile when they themselves are seeking aesthetic services. Each person/user with various user profiles has the ability to switch from one user profile to the next.

The invention also provides a rating system from 1-5, where client users can rate the providers and companies from least satisfied 1 to most satisfied 5 and provide comments regarding their service experience. The rating system and comments section will allow other client users to review the satisfaction of prior clients to help determine the best provider and company for the service needed by the client. The rating system and comments section of clients can help providers and companies understand client needs to ensure a pleasant and satisfactory client experience.

A person skilled in the art would readily appreciate that the present disclosure may be a basis for modifying or designing other structures for carrying out the same purposes of the present disclosure. Such equivalent constructions do not depart from the teachings of the disclosure as set forth in the present specification, drawings, and claims. The novel features, which are believed to be characteristic of the disclosure, both as to its organization and method of operation, together with further purposes and advantages, will be better understood from the following description when considered in connection with the figures provided herein.

### BRIEF DESCRIPTION OF THE DRAWINGS

A person skilled in the art would appreciate that these figures are provided for the purposes of illustration and description only and are not intended to act as limits of the present disclosure.

FIG. 1 is a diagram showing company user view of the activity feed or Global Feed.

FIG. 2 is a diagram showing the company user view of a company profile page.

FIG. 3 is a diagram showing the company user view of the company profile, where services provided by company can be added.

FIG. 4 is a diagram showing the company user view of the company profile, where the devices used in relation to a service can be added.

FIG. 5 is a diagram showing the company user view of the company profile, where a company user can add the duration for each of the services added and saved by company.

FIG. 6 is a diagram showing the company user view of the company edit profile page.

FIG. 7 is a diagram showing client user view of the activity feed or Global Feed.

FIG. 8 is a diagram showing the client user search page.

FIG. 9 is a diagram showing the client user view when the client is searching for a specific service within a specified location.

FIG. 10 is a diagram showing the client user view of how the services are populated during a search.

FIG. 11 is a diagram showing the client user view of when a category of services are chosen, revealing the associated subcategories.

FIG. 12 is a diagram showing the client user view when a category of services is selected and the providers within the specified search parameters are revealed.

FIG. 13 is a diagram showing the client user view when a category of services are selected and the companies within the specified search parameters are revealed.

FIG. 14 is a diagram showing the client user view of the calendaring system to make an appointment with a specified company.

FIG. 15 is a diagram showing client user view of the appointments of client user in a list format.

FIG. 16 is a diagram showing client user the client view of the client inbox and chat feature.

FIG. 17 is a diagram showing provider user view of the activity feed or Global Feed.

FIG. 18 is a diagram showing the provider user view of the provider inbox.

FIG. 19 is a diagram showing the provider user view of the provider profile when provider is editing his or her information.

FIG. 20 is a diagram showing the provider user view of provider profile after profile information has been submitted, saved and available for view by clients.

FIG. 21 is a diagram showing the settings page that is consistent for all user types, client users, provider users and company users.

FIG. 22 is a diagram showing the setting page when the edit icon is chosen where information can be submitted or previously submitted information be edited.

### DETAILED DESCRIPTION OF THE PREFERRED EMBODIMENTS

The following description is not to be interpreted or applied in a limiting sense, but as an illustration of the general principles and aspects of the invention. The breadth and scope of the present inventions are set forth by the claims. Various inventive features are described below that can each be used independently of one another or in combination with other disclosed and undisclosed features.

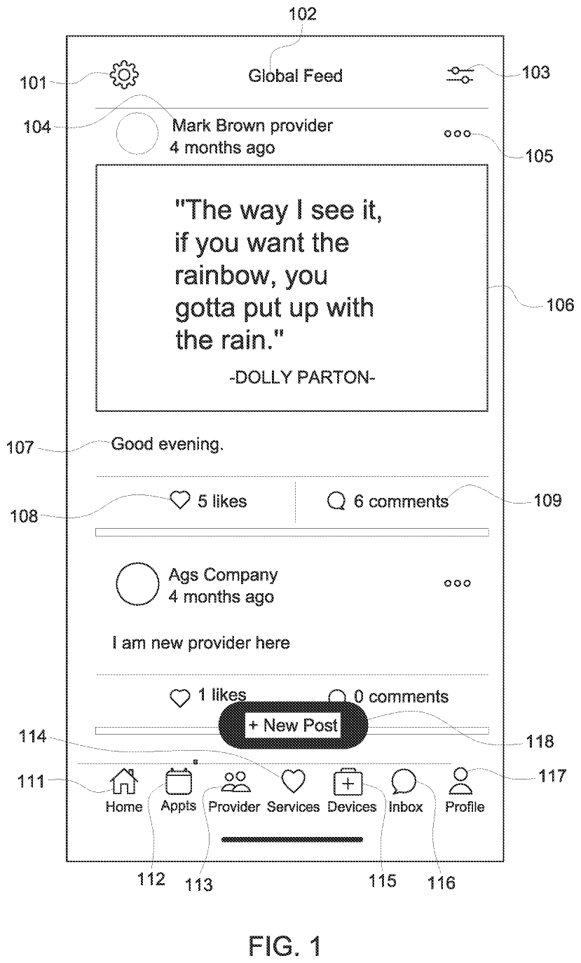

FIG. 1 depicts an embodiment of the present disclosure demonstrating the company user view of the platform. When entering the platform, the first page that is revealed is the Global Feed 102. The Global Feed 102 features all the posts 106 of other company users and provider users. The posts 106 can include photos, videos, and text 107. At the top of each post, the name of the originator 104 is shown, and using the three-dot icon 105, allows the posts to be shared and/or directed to the poster's profile. The posts can be liked 108 by the company, other providers and users and comments 109 can be submitted pending approval of the provider or company that has made the post. When in the Global Feed 102, a company can press on the New Post icon 118, and generate a new post including photos, videos and text. The company user can scroll using the user's finger to reveal other posts by providers and companies. The posts are organized and revealed in chronological order where the top posts are most recent posts. Further, a client, provider or company user can filter the posts by location.

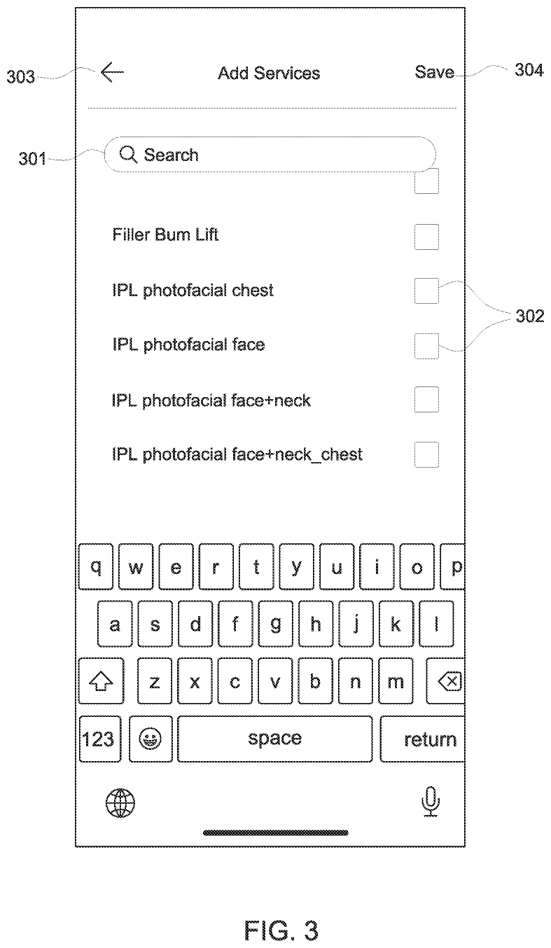

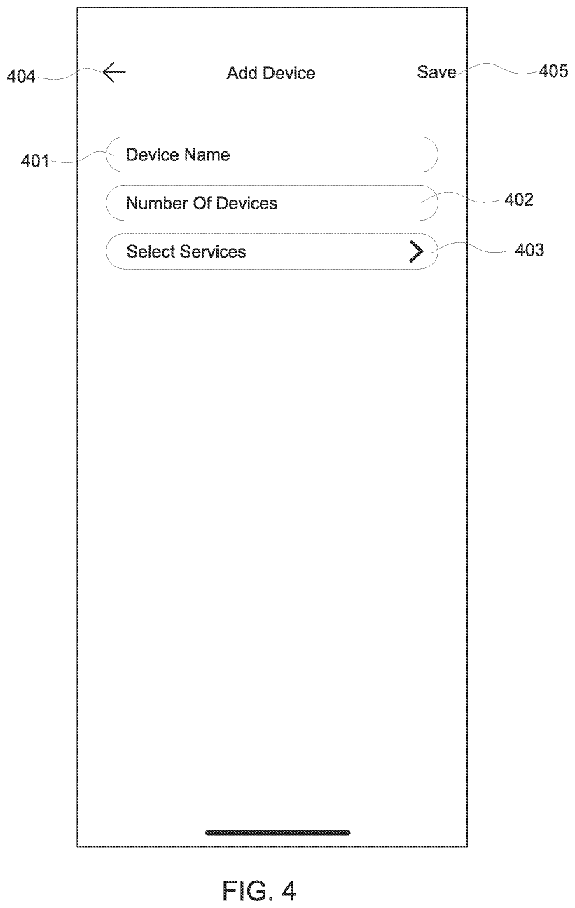

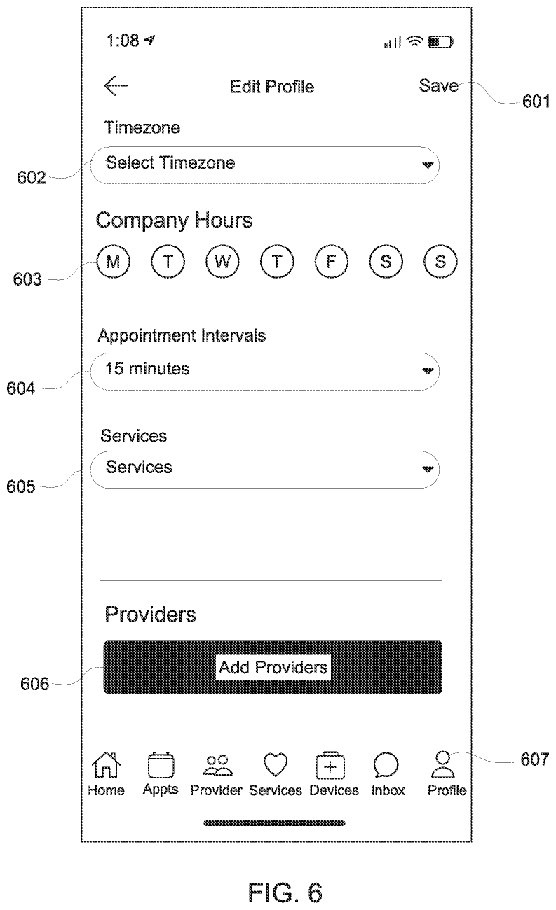

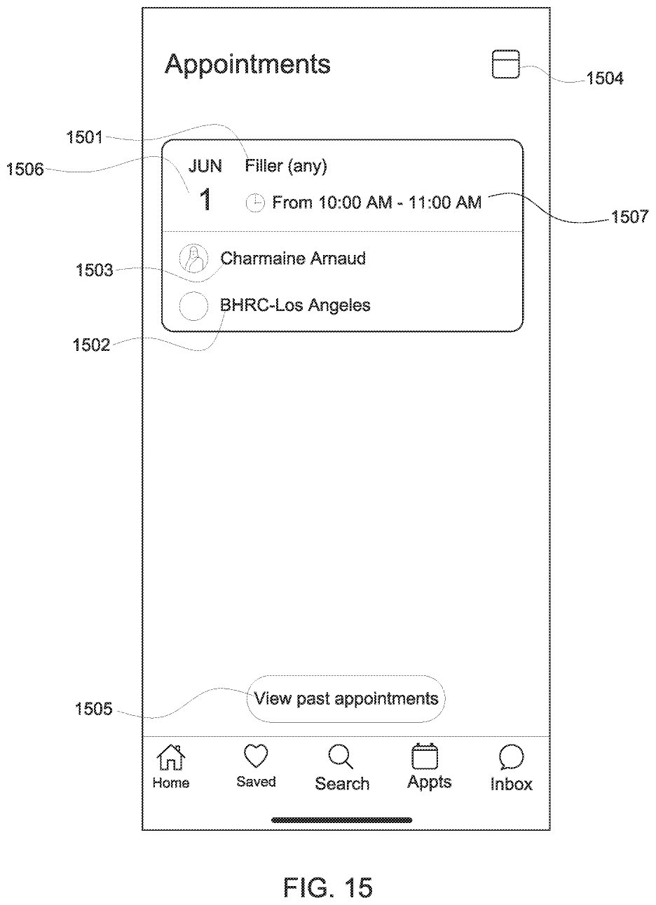

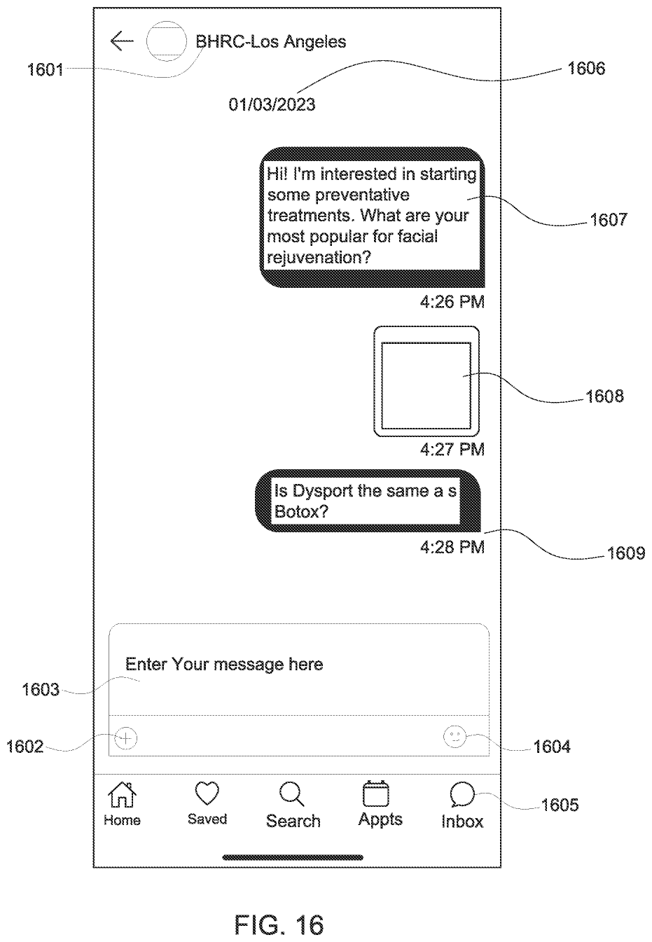

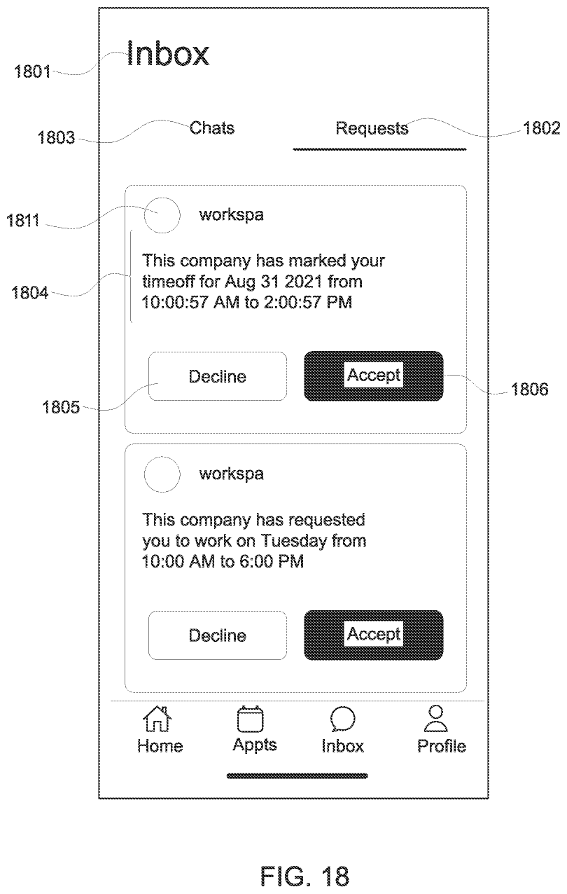

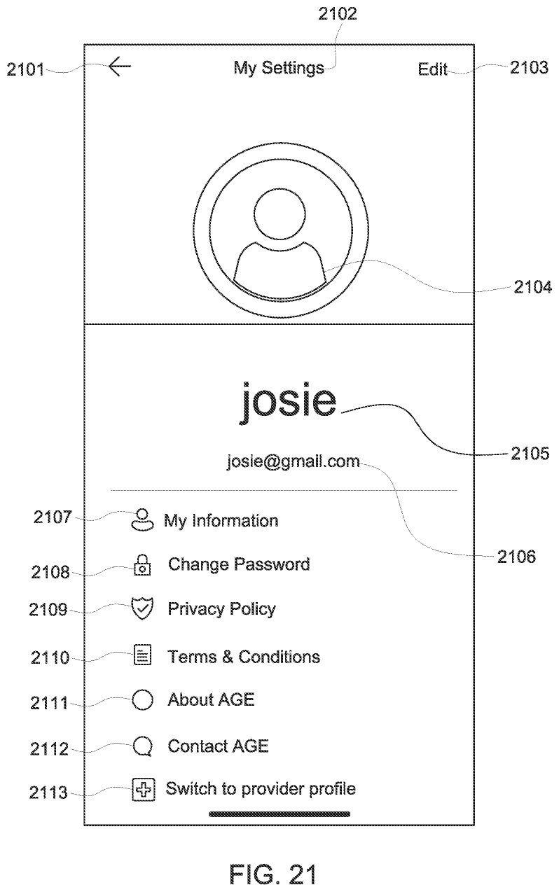

The view provides a settings icon 101 and when the settings icon is pressed it takes you to FIG. 21. Further a filter icon 103 allows the company to filter through the different services available on the platform. The bottom of the screen, the functionalities of a company user are provided, including a home icon, 111, appointments icon 112, provider icon 113, services icon 114, devices icon 115, inbox icon 116 and profile icon 117. The home icon 111 on the bottom of the page takes the company user to the global feed FIG. 1. The appointment icon 112 takes the company user to a calendar view of all the appointments for the company, similar to FIG. 15. The provider icon 113 takes the company user to see all the providers that are within the company's network. The services icon 114 takes the company user to view and modify the listed services of the company, as shown in FIG. 3. The devices icon 115 takes the company user to view and modify the types of devices and machines offered by the company as shown in FIG. 4. The inbox icon 116 takes the company user to view the messages and chats initiated by the client users. Companies and providers cannot solicit clientele by contacting client users directly, they may reply to messages and inquiries sent by clients as shown in FIG. 16. Further, the inbox icon 116 shows requests from providers, including requests for time off and requests to be included within the company listing of providers. The company user can accept or decline any of provider's request as shown in FIG. 18. Company users can also send requests to providers to add that particular provider to their provider list or request to work specified hours, see FIG. 18. The profile icon 117 takes the company user to its company profile identified as FIG. 6.

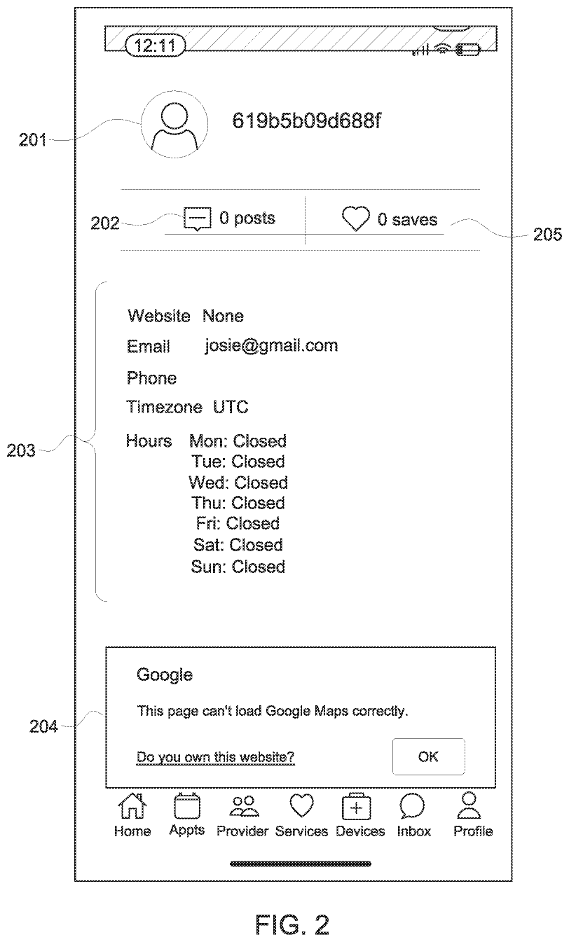

FIG. 2 depicts an embodiment of the present disclosure demonstrating the company user view of the company profile when the icon 117 of FIG. 1 is selected. The page shows the company name 201, shows the posts 202 posted by the company user and the number of saves 205 that the company user received. The company user information 203 is shown including website, email, phone, time zone and hours of operation. Using an integrated map using GPS, the location of the company is revealed 204.

FIG. 3 depicts an embodiment of the present disclosure demonstrating the page revealed when the services icon, 114 is selected. Within the services page, a company can search the services through a search bar 301 and select each of the services they will be providing 302. Once all the services are added, the company user can press save 304 and have the services saved.

FIG. 4 demonstrates the ability for a company user to add devices that they use for treatment and is revealed when the device icon 115 is selected. The device name can be selected by pressing the device name icon 401, the number of devices can be identified by selecting the number of devices icon 402 and the associated services that are rendered via the device can be selected by selecting the select service icon 403. Upon entering the desired information regarding the device to be entered, the company user can save the entry by pressing save, 405 and go back to the main menu by selecting the back button 404.

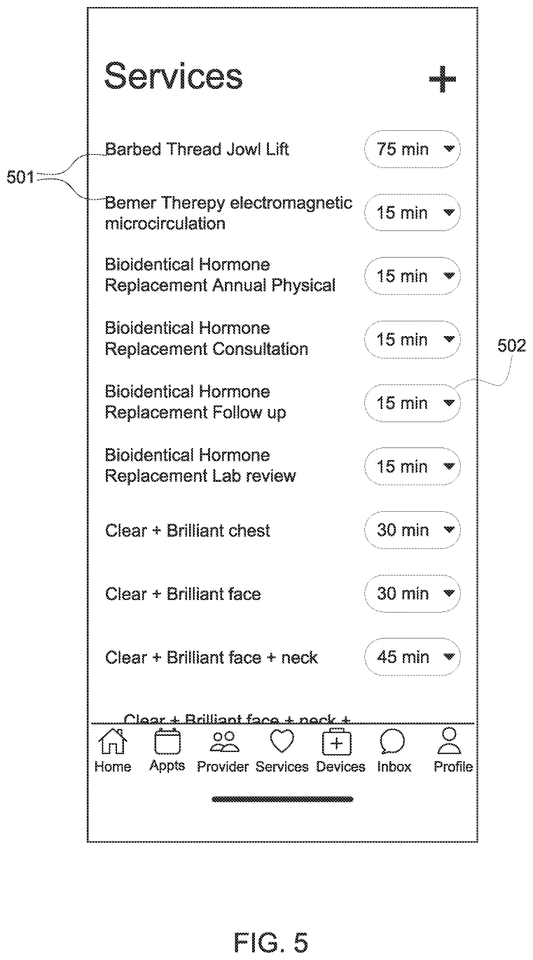

FIG. 5, demonstrates a list of the services that have been added by a company user 501. The company can select the amount of time each treatment requires in 15-minute intervals by selecting the time icon 502, where a drop-down menu of time is revealed, and the company can choose the time requirement for each service indicated.

FIG. 6 demonstrates the page where a company user can edit the profile information to provide company user time zone 602, choose their company hours by each day of the week 603, provide appointment intervals in 15-minute increments, provide the services that they provide 605 and add providers 606. Upon adding providers, a request is sent to each respective provider, and the provider is revealed on the company profile only after the provider has accepted the request. When the add provider icon is selected 606, a list of registered providers are revealed and the using a search box the company can search the provider and request to be added to their company profile.

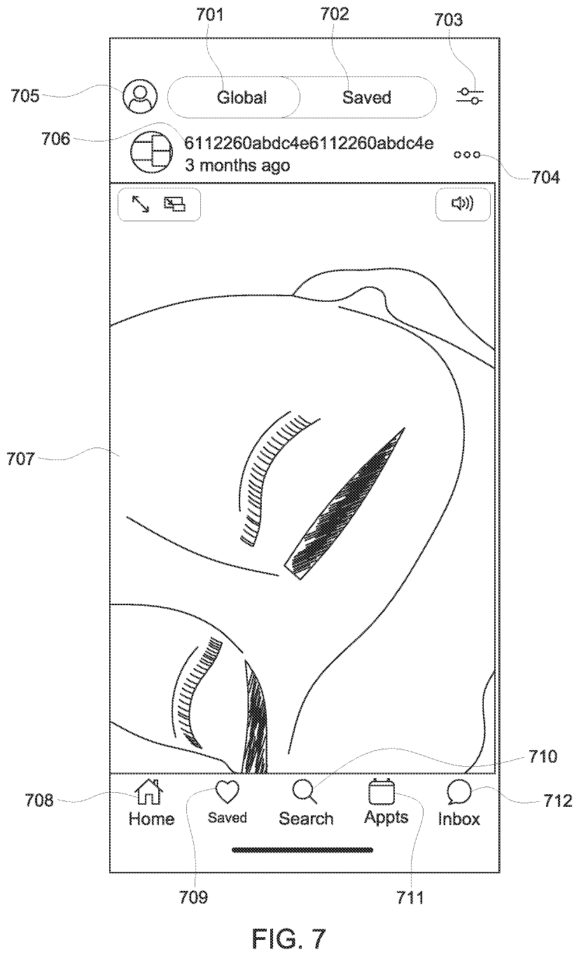

FIG. 7 depicts an embodiment of the present disclosure demonstrating the client user view of the platform. When entering the platform, the first page that is revealed is the is the Global Feed, 701. The client user can switch from the global feed to the saved posts by sliding their finger from global icon 701 to the saved icon 702. The saved icon 702 shows the saved posts of the client. The 705 icon shows the client user profile photo. The global feed shows posts 707 posted by both registered providers and companies. Each post 707, in the form of videos, photos and text identifies the provider or company name 706 that has made the post. Using the three-dot icon 704, allows the client user to share the post and/or be directed to the profile of the author of the post. The filter icon 703 allows the client user to filter through the different services available on the platform.

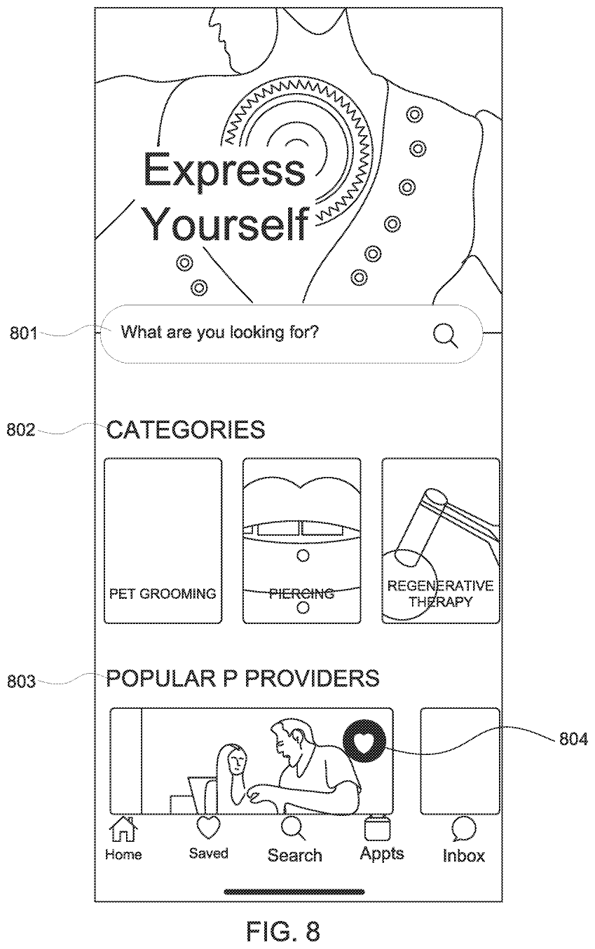

The bottom portion of the client user profile features a home icon 708, a saved icon 709, a search icon 710, an appointments icon 711 and an inbox icon 712. The home icon takes the client user to the global feed of FIG. 7. The saved icon 709, takes the client user to the saved providers and companies. The search icon 710, takes the client user to FIG. 8, where the client user can search for services per chosen criteria. The appointment icon 711 takes the client user to FIG. 15, where the client user can review its pending and past appointments. The inbox icon 712 takes the client user to the inbox where they can review replies to messages and inquiries sent by the client.

FIG. 8 demonstrates the search area for a client user, where in the “what are you looking for icon?” icon 801 can enter the services that the client user is seeking. The search page also provides categories of services, 802 such as pet grooming, piercing, regenerative therapy and etc. The search page further provides a listing of popular providers 803, and each popular provider has a heart icon 804 where the client user can click on the provider and save it to their saved list. The services to be provided on platform include but are not limited to, barber shop services, body contouring, consults, eyebrow grooming, eyelash extension, facials and skin care, hair restorative services, hair salon services, general health and wellness, injectables, intense pulse light (IPL), hair restoration services, laser hair removal, make up artists, massage services, micro needling, nail services, polydiaxanone (PDL) threads, pet grooming, piercing, regenerative therapy, Radio Frequency (RF) skin tightening services, surgical services, tattoo services, teeth cosmetics, ultherapy and waxing.

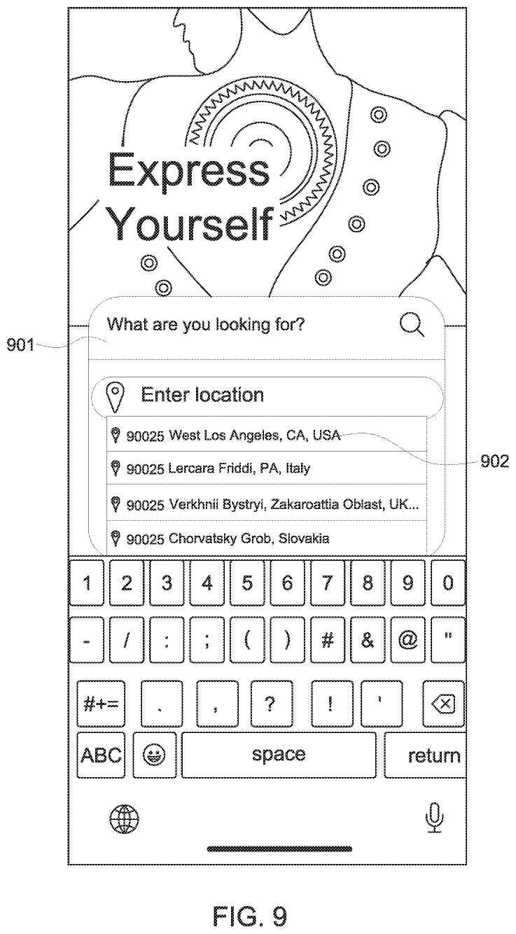

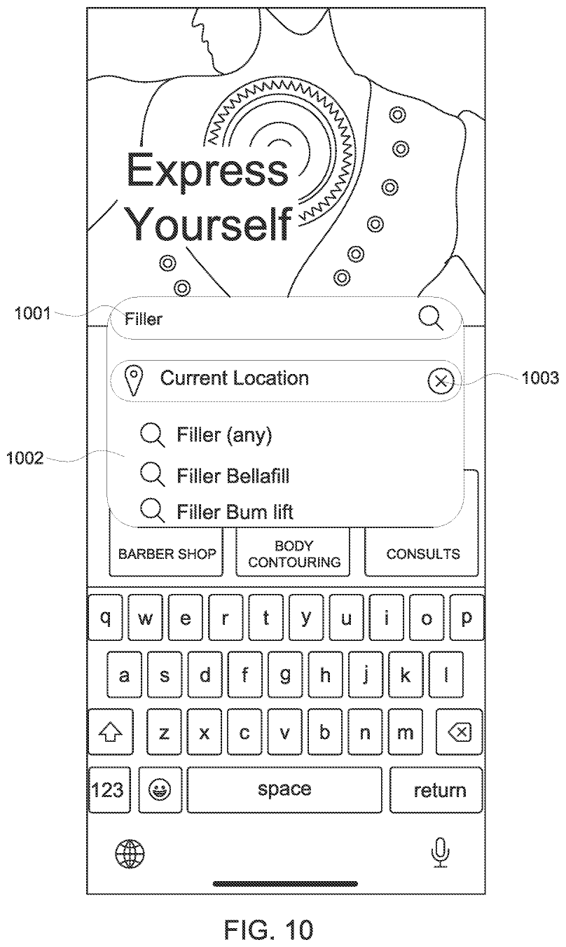

FIG. 9 demonstrates the search criteria available to a client user during a search and upon selecting the “what are you looking for?” icon 901. Once the search icon 901 is selected, another search bar appears where the client user can search by narrowing its search by location 902. The client user can search by entering an address, a city or a zip code where they are seeking services. The platform will generally default to the current location of the client user as evidenced by FIG. 10, where a client user can enter the services, they are searching for 1001, and the platform assumes the current location. Further, the search provides a list of services 1002 related to the search term entered. The client user can press the “x” icon 1003 and enter the desired location where services are sought.

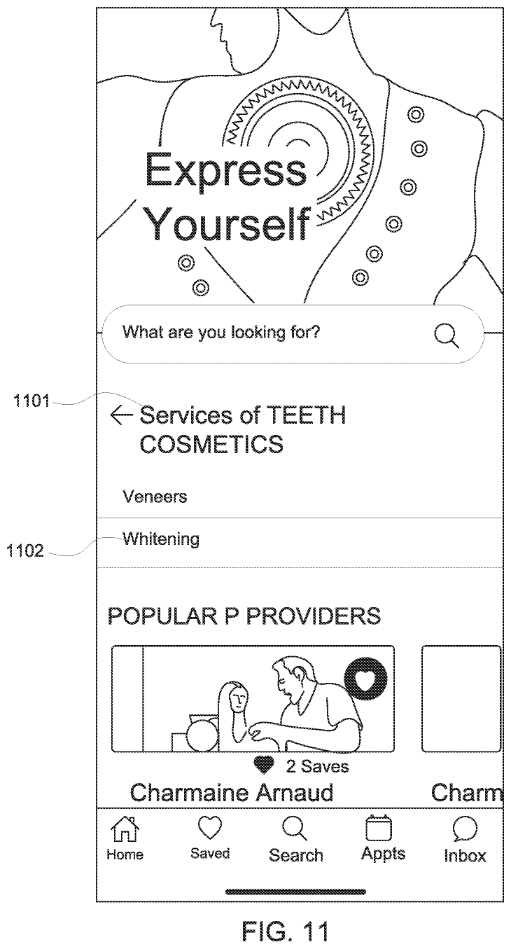

The services are organized by categories and subcategories as shown in FIG. 11. FIG. 11 shows the general services of “TEETH COSMETICS” 1101 as selected by a client user. The general search reveals the subcategories of that service such as veneers and whitening 1102. The client user can choose the appropriate sub service of choice. Once the services are chosen, the platform will provide the client user with a list of companies and providers that the client can choose from within the specified location.

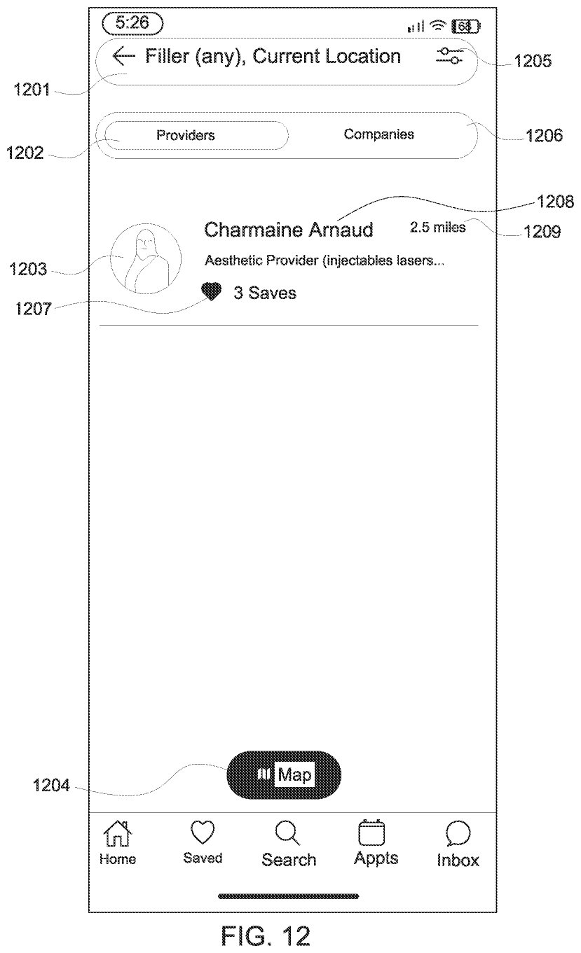

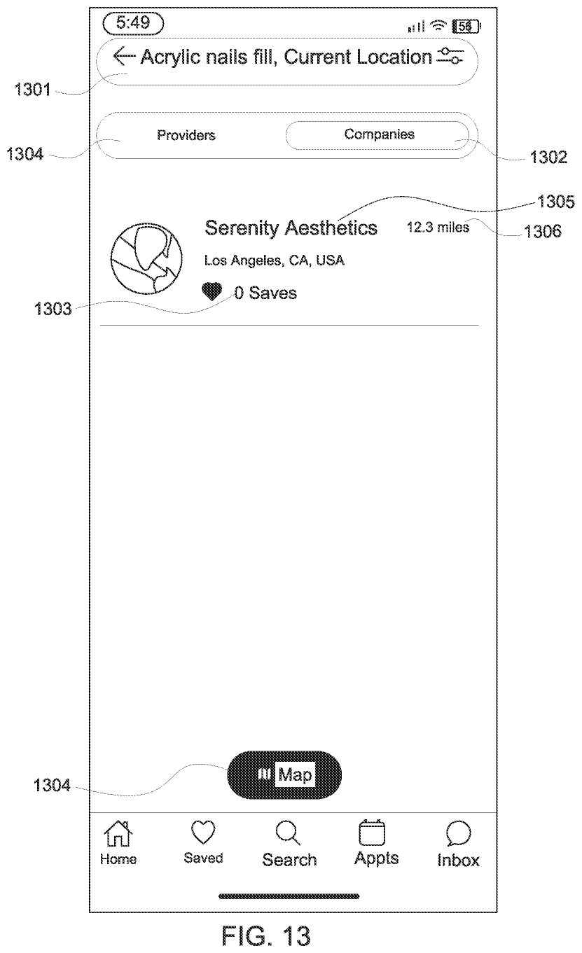

FIG. 12 shows the client user's chosen service within a specified location 1201. The filter icon 1205 allows the reset or change any of the specified services or location. The client can choose either by provider 1202 or company 1206 by sliding or selecting the icon for providers 1202 or companies 1206 which is shown in FIG. 13. When the provider icon is chosen 1202, the providers within the specified location are revealed 1203 where their information including name 1208, and distance 1209 is shown and the number of times the provider has been saved 1207. The client user can press on the map icon 1204 to reveal all the listed providers and companies configured on a map and make a selection from the map.

FIG. 13 is demonstrated the list of companies based on the client user search 1301. This page is revealed when the client selects the company's icon 1302, instead of the provider icon 1304. The list of companies is listed by name of company 1305, the distance from the chosen location 1306 and the number of times other client users have saved the respective company 1303. The client user can press on the map icon 1304 and look at the all the listed companies configured on a map and select from the map.

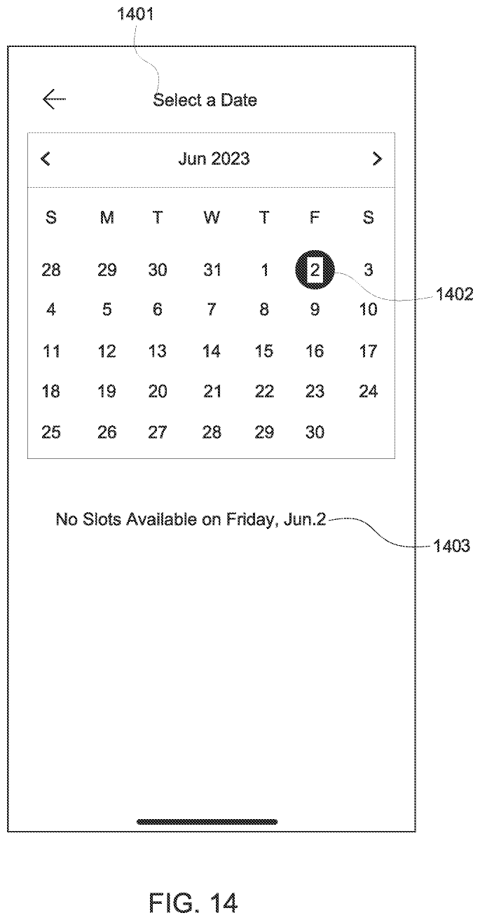

Once a company is chosen from the search results, the client user can elect to make an appointment through the platform, however, if a provider is chosen the client user must make an appointment through the associated company and select the desired provider. FIG. 14 shows the calendar-based appointment system where the client user can choose the date of interest and press on the date of interest. The calendar system prompts the client user to select a date 1401 by clicking on the calendar date that the client user desires 1402. Once the date of interest is selected, below the calendar either the times available on that date are revealed or that no slots are available on that specified date 1403.

FIG. 15 demonstrates active and future appointments of the client user. Each appointment is identified by date 1506, by the type of services 1501, by time 1507 by provider 1503 and by the company 1502. Further, the client user can view all future appointments by selecting the calendar icon 1504 to view the appointments in a calendar format. The client user can further view their past appointments by selecting view past appointments icon 1505.

The client user is the only type of user that can initiate messages to providers and companies. Companies and providers cannot initiate contact with a client but once the client user has reached out to the specific provider or company they can respond. FIG. 16 shows the client user's inbox when the client user selects the inbox icon 1605 and the client's conversations with a company or provider 1601 are revealed. The chat feature shows the date the message was sent 1606, the messages sent 1607, the photos sent 1608 and each message is date stamped 1609. The client can enter text in the message composition box 1603, add attachments such as photos or videos from the phone by using the add icon 1602 and use emojis by selecting the smiley icon 1604.

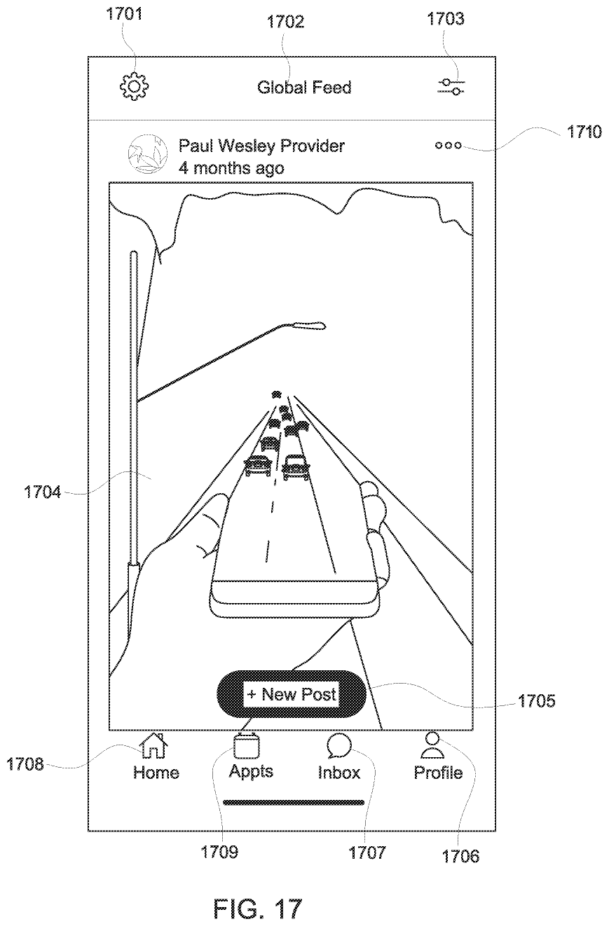

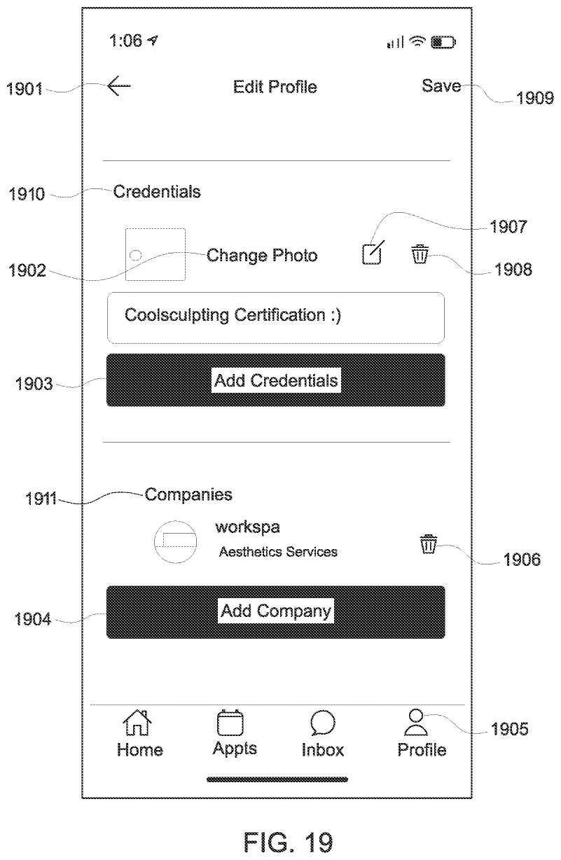

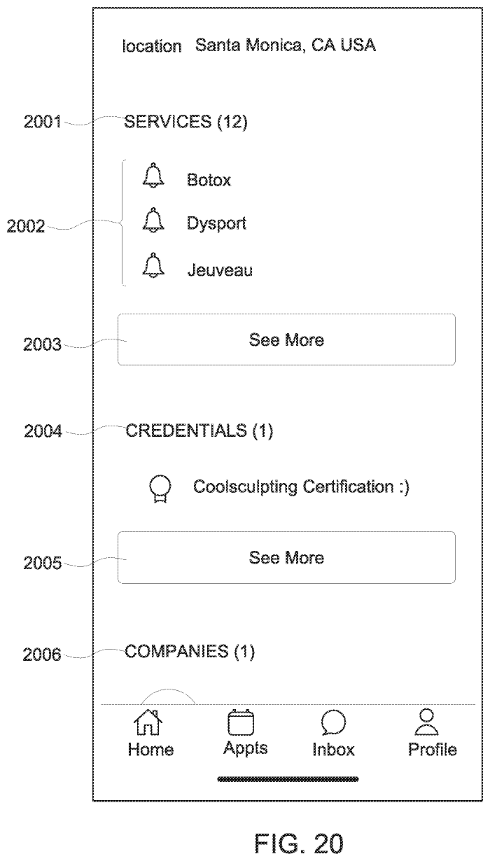

FIG. 17 depicts an embodiment of the present disclosure demonstrating the provider user view of the main page on the platform. When entering the platform, the first page that is revealed is the Global Feed, 1702. The provider user is able to see posts 1704 made by other providers and companies in the form of photos, videos and text. The provider global feed displays an add new post icon 1705, when selected the provider user can post a photo, video or text of their choosing to be featured on the Global Feed. The main page features the settings icon 1701, where the provider user can edit its settings including their website, email information, time zone, and hours of operation. Further a filter icon 1703 allows the provider user to filter through the different services available on the platform. From the services available, the provider user can click on a specific service(s) they want to view and only those posts with the service(s) chosen will appear on the Global Feed. Using the three-dot icon 1710, allows the posts to be shared and/or directed to the poster's profile. The provider users page features a home icon 1708, an appointment icon 1709, an inbox icon 1707 and a profile icon 1706. The home icon 1708 directs the provider user to the Global Feed 1702. The appointment icon directs the provider user to view pending appointments made by clients both in a list format FIG. 15 and a calendar format FIG. 14. The inbox icon 1707 leads to chats initiated by clients and requests and chats initiated by companies, FIG. 18. The profile icon 1706, takes the provider user to its profile information where credentials, company affiliations, and services are listed and can be modified, FIG. 19 and FIG. 20.

FIG. 18 shows the provider user's inbox 1801 where communications are organized by chats 1803 and requests 1802. The chats icon 1803 show all the communications initiated by client users, and company users. The requests icon 1802, shows all the requests submitted by company users for provider user approval. All requests 1802 are shown in a list format indicating the company 1811 from which the request has been submitted. Each request identifies the request information 1804, including the request time and associated dates. Each request includes an accept icon 1806 or decline icon 1805, where the provider user can either accept or decline the request.

When the provider user selects the profile icon 1905, the provider user's information is presented as shown in FIG. 19 and provider user can edit the information previously entered. The provider user can enter his or her credentials 1910 which will be listed in the profile, the companies with which provider user is employed by, and services provider user provides. The provider user can change his or her photo 1902, can write a text or title regarding his or her credentials by selecting the text icon 1907, or delete a credential entry by selecting the trash icon 1908. The provider user can select the add credentials icon 1903 to enter its credentials or certifications. The credentials and certifications will be reasonably and randomly verified by the platform to ensure that accurate information is provided. Further the profile shows the companies 1911 with which the provider is employed by. Provider user can add companies by selecting add company icon 1904 and provider user can delete any of the companies on the profile by selecting the trash icon 1906. Once the provider user has made the requisite changes to the profile, provider user can press the save icon 1909, to save the information and publish for client viewing. The provider user can select the back icon 1901, to go back to the profile page FIG. 20.

FIG. 20, shows the profile of the provider user after it has been modified and saved, the profile of a provider user shows the number of services provided 2001 and identifies each of the services in a list format 2002, and with selecting the see more icon 2003 the rest of the services are revealed. Further the provider user profile shows any credentials and certifications 2004 of the provider user. Also, the provider user profile shows all the companies 2006 that the provider user is employed by.

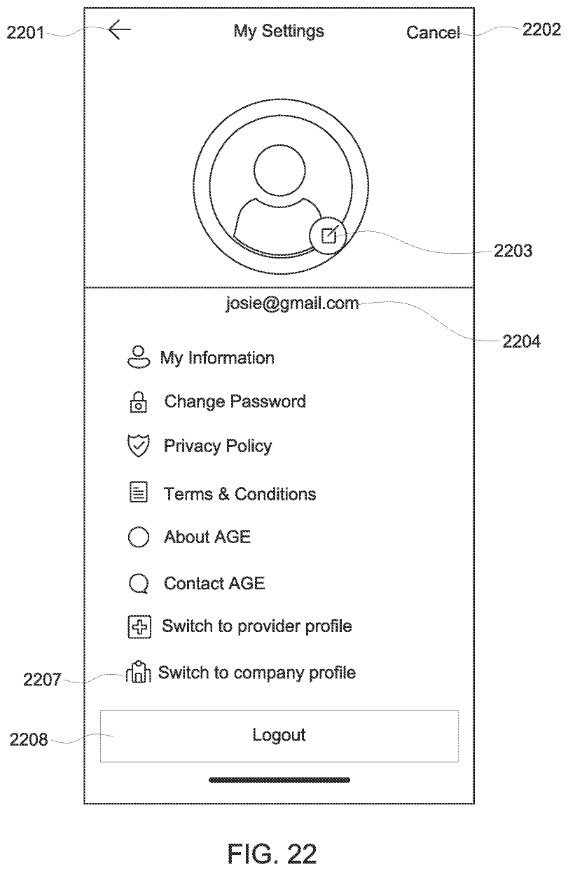

FIG. 21, shows the setting page that is consistent among all three types of user profiles, company user profile, client user profile and provider user profile. The settings page for the client user is entered by selecting the profile icon 705, for the company users the setting page is accessed by selecting icon 101 and provider users can access the setting page by selecting the settings icon 1701. The setting page is identified as my settings 2102 where the photo of the user is shown 2104, the name of the user is shown 2105, and the email of the user 2106. The user can select the edit icon 2103 to edit the photo of the profile, FIG. 22. The user can select the back icon 2101 to return to the prior page. The setting page also has my information icon 2107 where the user information such as name and email are shown and can be modified by any of the users. The change password icon 2108 allows the user to change the password to the platform. The Privacy Policy icon 2109 reveals the privacy policy of the platform. The Terms and Conditions icon 2110 reveals the terms and conditions of the platform. The About AGE icon reveals information and text regarding the platform. The Contact AGE icon reveals contact information of the platform to all users. The Switch to provider profile icon 2113 appears for either company users or client users, that also have provider profiles and elect to switch to the provider profile.

FIG. 22 demonstrates a continuation of FIG. 21 where a client user has selected the edit icon 2103. The settings page of FIG. 22 is the same for company users and provider users. In the settings page for the client user when the edit icon 2103 is selected, a client user can change its photo by selecting the edit icon 2203. After changing the photo client user can either save the photo, or if no changes are needed select the cancel icon 2202. The client user can also elect the back icon 2201 to go back to the prior page, FIG. 21. The setting page further reveals the Switch to company profile 2207, where a client user can switch to a company user profile. The user can also press the logout icon 2208 and logout of the platform. An individual can have a company user profile if they own a company, can have a provider profile if they are also a provider and a user profile to search for services for personal use. Each user can switch from one profile type to the other with a press of an icon revealed in the settings page.

What is claimed is:

1. A computer implemented method of an online e-commerce platform comprising:
company users, provider users and client users;
where company users can register their companies with the platform presenting their aesthetic services to client users;
where provider users can register with the platform individually as providers associated with a company and present their aesthetic services to client users;
where client users seeking specific aesthetic services can search the platform for providers and companies providing such services within a specified geographical location with the use of global positioning system (GPS).

2. The e-commerce platform of claim 1, further comprising a global feed where company users and provider users can post photographs, videos and text that will be featured on the global feed.

3. The e-commerce platform of claim 2, further comprising the ability of a client user, company user and provider user to like, comment and save posts made by provider users and company users.

4. The e-commerce platform of claim 1, further comprising a calendar system where the client user can make an appointment directly through the platform with company user.

5. The e-commerce platform of claim 4, further comprising the ability of the client user to make a payment directly through the platform for the services to be rendered by company user and provider user.

6. The e-commerce platform of claim 1, further comprising a chat feature where only a client user can initiate communication with a company user and provider user and share photos, videos and text communications with provider user and company user at which point company user and provider user can engage in communication with client user.

7. The e-commerce platform of claim 1, further comprising an internal calendaring system for company users, where company users can set appointment duration time for each aesthetic service the company user provides, and the internal calendaring system will calculate appointment duration time and determine available time slots based on prior appointments and availability and generate appointment dates and time for client users.

8. The e-commerce platform of claim 1, further comprising the ability of company users to specify the type of devices used and available in association with each aesthetic service.

9. The e-commerce platform of claim 1, further comprising the ability to link each provider user with a company user.

10. The e-commerce platform of claim 1, where each company user and provider user identifies the scope of services provided, applicable certifications and credentials, work history and experience, their current location and an optional photograph.

11. The e-commerce platform of claim 1, where goods relating to aesthetic services are featured and available for purchase through the platform.

12. The e-commerce platform of claim 11, where provider users and company users can recommend goods to clients for use and clients can purchase recommended goods directly through the platform.

13. The e-commerce platform of claim 1, featuring a reward system for client users, where client users transacting through the platform, will gain rewards that can be applied to future services and the purchase of goods through the platform.

14. The e-commerce platform of claim 1, where one individual can have a client profile, a company profile and a provider profile, and can switch from one profile to another through the platform.

15. The e-commerce platform of claim 1 or claim 4, where a client user can filter and select at home aesthetic services.

16. The e-commerce platform of claim 1, where provider users and company users can host educational webinars on the platform.

17. The e-commerce platform of claim 1, further comprising a rating system for client users to rate providers and companies from 1-5, 1 being least satisfied and 5 being most satisfied.

18. A system comprising:
One or more processors; and
A computer-readable storage medium storing instructions which when executed by one or more processors, cause the one or more processors to perform operations comprising:
receiving and storing criteria associated of two types of users, a company user and a provider user;
generating a search result by matching client user criteria and the stored criteria associated with company user criteria and provider user criteria;
supplying the search result to a client device associated with the client user;
allowing a client user through the client device to select a provider user and company user giving the client user access to provider user and company user calendar and profile information.

19. The system of claim 18, further comprising establishing network communications between client user and provider and company user when client user elects to communicate with provider user and company user.

20. The system of claim 18, further comprising the matching criteria between client user and company and provider user to be the type of aesthetic service and the location of the respective company and provider user.
